(19) United States
(12) Patent Application Publication
(10) Pub. No.: US 2025/0222846 A1
(43) Pub. Date: Jul. 10, 2025

(54) Head Support for a Motor Vehicle Seating System, and Seating System

(71) Applicant: Bayerische Motoren Werke Aktiengesellschaft, Muenchen (DE)

(72) Inventors: Andreas BISSINGER, Muenchen (DE); Moritz FRENZEL, Muenchen (DE); Alexander STEGMAIER, Muenchen (DE); Lukas UTZIG, Saarbruecken (DE)

(21) Appl. No.: 18/853,159

(22) PCT Filed: Mar. 21, 2023
(86) PCT No.: PCT/EP2023/057207

§ 371 Date: Oct. 1, 2024

(30) Foreign Application Priority Data
Apr. 19, 2022 (DE) 10 2022 109 401.4

(51) Int. Cl. B60N 2/882; B60N 2/80

(52) U.S. Cl. CPC B60N 2/882; B60N 2002/899

(57) ABSTRACT

A head support for a motor vehicle seating system has a main body at least partly covered by a cushion, which main body is at least predominantly made of plastic. The main body has a rib structure with a plurality of ribs, by which respective rib chambers which are arranged in the vehicle longitudinal direction are divided from one another.

### BACKGROUND AND SUMMARY

The invention relates to a headrest for a motor vehicle seat system. The invention also relates to a motor vehicle seat system having such a headrest.

DE 10 2010 001 598 B3 discloses a seat assembly comprising a backrest, a support column arranged rigidly on the backrest, and a headrest assembly arranged on the support column. The headrest assembly comprises a rear portion arranged movably on the support column and a front portion arranged pivotably on the rear portion.

An object of the invention is to provide a headrest for a motor vehicle seat system and a motor vehicle seat system such that an ability of the headrest to bear mechanical loads can be particularly increased and the weight of the headrest can be kept particularly low.

This object is achieved by a headrest for a motor vehicle seat system and by a motor vehicle seat system having such a headrest in accordance with the independent claim(s). The dependent claims and the description relate to advantageous embodiments of the invention.

A first aspect of the invention relates to a headrest for a motor vehicle seat system. The motor vehicle is preferably in the form of a motor car, in particular a passenger car, utility vehicle or truck. The seat system is preferably in the form of a vehicle seat, in particular referred to as seat.

The finished motor vehicle preferably comprises the seat system. For example, the motor vehicle comprises a vehicle interior, in particular referred to as interior or passenger compartment, in which the seat system is arranged. The finished seat system preferably comprises the headrest. The headrest may in particular be referred to as vehicle headrest.

The seat system is preferably provided as a seat, or seating space, for a person in particular located in the vehicle interior. This means that the person can sit on the seat system. When the person is seated on the seat system, the person makes contact, preferably directly, with the seat system. For example, the person is a driver of the motor vehicle. Therefore, when the driver is in the vehicle interior of the motor vehicle, they can sit on the seat system, in particular while the motor vehicle is being driven.

The seat system preferably has at least one seat part, in particular formed separately from the headrest. The seat part may for example be in the form of a seat surface and/or a backrest of the seat system.

The headrest is intended to support the person's head. This means that the person seated on the seat system can support their head, in particular directly, on the headrest. The headrest therefore preferably has a support surface intended for supporting the person's head. The support surface is therefore preferably intended for direct contact of the headrest with the person's head.

The headrest has at least one, in particular exactly one main body encased by upholstery at least in certain regions, in particular completely. In other words, the upholstery at least partially, in particular completely, surrounds the main body. This means that the main body is at least partially, in particular completely, covered by the upholstery. For example, the upholstery has at least one upholstery cover, in particular referred to as seat cover. For example, the upholstery, in particular the upholstery cover, comprises the support surface.

The main body is at least predominantly, in particular completely, made from a plastics material. In other words, the material from which the main body is at least predominantly, in particular completely, made is a plastics material. The plastics material may in particular be referred to as plastic.

In order to be able to particularly increase an ability of the headrest, in particular of the main body, to bear mechanical loads and to be able to keep a weight of the headrest, in particular of the main body, particularly low, the invention provides that the main body comprises a rib structure having a plurality of ribs, which partition off respective rib chambers from one another. In other words, the respective rib chambers are delimited or formed, in particular directly, by at least one of the ribs, in particular by multiple ribs. This means that the respective rib chambers are each at least partially surrounded by at least one of the ribs, in particular by multiple ribs.

The fact that the respective rib chambers are partitioned off from one another by the ribs can be understood in particular to mean that at least one of the ribs is arranged between two respective, in particular directly, adjacent rib chambers.

The respective rib chamber can in particular be understood to be a respective cavity in particular arranged within the main body and/or formed by the rib structure. This means that the respective rib chamber is preferably free of material, in particular of the plastics material. The rib structure may in particular be referred to as rib pattern or ribbing. The respective rib may in particular be referred to as a respective strut.

The respective rib chambers are, in particular in the installed position of the headrest, or of the seat system, in the motor vehicle, in particular at least substantially aligned in the motor vehicle longitudinal direction. This means that a direction of longitudinal extent of the respective rib chamber in particular at least substantially corresponds to the vehicle longitudinal direction. In other words, a demolding direction of the respective rib chamber, which demolding direction in particular is provided to produce the rib structure, or on production of the rib structure, in particular the respective rib chamber, in particular in the installation position of the headrest, or of the seat system, in the motor vehicle, is aligned in the vehicle longitudinal direction. This means that the demolding direction runs at least substantially in the vehicle longitudinal direction.

The ability of the headrest to bear mechanical loads can be understood in particular to mean a resistance of the headrest to mechanical loading, in the event of which in particular the headrest does not collapse. The mechanical loading is for example a force acting on the headrest. This means that in particular a strength and/or a stiffness of the headrest can be particularly high.

The invention is based in particular on the following findings and considerations: in principle, the headrest, in particular the main body is made from metal, for example steel. As a result, the headrest can withstand mechanical stresses, for example a pendulum impact or a crash of the motor vehicle, in particular without problems. In particular, a strength of the headrest, in particular of the main body, can be particularly high in this case. However, the weight of the headrest, in particular of the main body, may be particularly high. This can have an adverse effect on a vibration behavior of the headrest, in particular of the seat system. This can be the case for example in that a natural frequency of the seat system, referred to in particular as first seat natural frequency, can be particularly lowered by especially high masses in the headrest region. This can have an adverse effect on the comfort of the motor vehicle.

By contrast, the weight of the headrest according to the invention, in particular by virtue of the main body being made from the plastics material, can be kept particularly low. The headrest according to the invention is therefore particularly lightweight, in particular because the steel, which is in particular especially heavy, can be omitted. The rib structure makes it possible to particularly increase the ability of the headrest according to the invention, in particular of the main body, to bear mechanical loads. Therefore, the headrest, in particular the main body, can particularly reliably withstand mechanical loads acting on the headrest, in particular on the main body. This makes it possible to particularly increase a safety, in particular a passive safety, of the motor vehicle. The headrest can therefore withstand in particular all the loads arising during operation of the motor vehicle, for example from the pendulum impact or the crash. The rib structure at the same time optimizes the headrest, in particular the main body, in terms of its mass, referred to in particular as overall mass. This means that the main body, or the rib structure, can be configured optimally, as a result of which a mass of the main body can be kept particularly low. Therefore, the rib structure can in particular be referred to as an ideal ribbing, since in particular the headrest can withstand all of the loads arising during operation of the motor vehicle with as low a mass of the main body as possible, in particular without the main body collapsing. The weight of the headrest, in particular of the main body, can therefore be kept particularly low. This means that the mass of the headrest can be reduced by means of the headrest according to the invention. As a result, for example a fuel consumption or an electrical energy requirement, in particular necessary for driving the motor vehicle, of the motor vehicle can be kept particularly low. The particularly low mass of the headrest, in particular of the main body, also makes it possible to particularly improve the comfort of the motor vehicle, in particular a driving comfort.

A further embodiment provides that the headrest has at least one holding element for, in particular directly, holding the headrest on the seat part, formed separately from the headrest, of the seat system. In other words, the headrest is connected or can be connected, in particular directly, to the seat part of the seat system via the holding element, with the seat part being formed separately from the headrest. This means that the headrest is fastened or can be fastened, in particular directly, to the seat part by means of the holding element. This means that the seat system is not in the form of an integral seat, in particular a fully integral seat. The headrest is therefore preferably not in the form of an integral headrest, in particular a fully integral headrest. This makes it possible to procure for example an adjustment function of the headrest, in particular relative to the seat part. As a result, the seat system, in particular the headrest, can be adapted particularly ergonomically, in particular as required. In this case, in particular the comfort of the motor vehicle, in particular of the seat system, can be particularly increased.

The holding element is preferably part of the headrest. This means that the finished headrest comprises the holding element. As an alternative, it is possible for the holding element not to be part of the headrest. This means that the holding element may be formed separately from the headrest. The holding element is preferably formed separately from the main body.

It is preferably provided that the headrest, which is held, in particular directly, on the seat part via the holding element, can be reversibly detached from the seat part. In other words, the headrest is reversibly fastened to the seat part. This means that the headrest can be reversibly connected to the seat part and reversibly removed from the seat part via the holding element. This makes it possible to retrofit, or exchange, the headrest for example with particularly little effort.

The fact that the headrest can be reversibly detached from the seat part can be understood in particular to mean that the headrest can be nondestructively detached from the seat part. The headrest can thus be reconnected to the seat part after being detached from the seat part, in particular without effecting a repair. This means that the headrest is in the form of a headrest that can be taken off of the seat part. The headrest can thus in principle be taken off of the seat part.

It is preferably provided that the holding element is received or can be received in a receiving region of the main body, with a mounting direction for receiving the holding element in the receiving region, in particular in the installed position of the headrest, in particular of the seat system, in the motor vehicle running in the vehicle longitudinal direction. In other words, the holding element in the state removed from the main body can be arranged in the receiving region of the main body by moving the holding element relative to the main body in the mounting direction, with the mounting direction running at least substantially parallel to the vehicle longitudinal direction. This means that the receiving region, in particular in the installed position of the headrest in the motor vehicle, is aligned at least substantially in the vehicle longitudinal direction. This makes it possible to produce the headrest with particularly little effort. In particular, this makes it possible to particularly increase the ability of the headrest to bear mechanical loads at the same time.

A further embodiment provides that the main body, in particular the headrest, is free of metal, in particular steel. In other words, the main body, in particular the headrest, is not made from metal. This means that the main body, in particular the headrest, preferably does not comprise any metal. This makes it possible to keep the weight of the headrest, or of the main body, particularly low.

A further embodiment provides that the headrest has the support surface intended for supporting the person's head. It is preferably provided that the rib chambers are closed on a side facing the support surface by a wall of the main body. In other words, the rib chambers are closed to the front, as seen in the motor vehicle longitudinal direction, by the wall of the main body in the installed position of the headrest, in particular of the seat system, in the motor vehicle. This means that the respective rib chamber is covered, in particular directly, to the front on the side facing the support surface, or as seen in the vehicle longitudinal direction, by the wall. The respective rib chamber is therefore delimited, in particular directly, to the front on the side facing the support surface, or as seen in the vehicle longitudinal direction, by the wall of the main body. This makes it possible to particularly increase the ability of the headrest, in particular of the main body, to bear mechanical loads.

As an alternative or in addition, it may be provided that the rib chambers are at least partially, in particular completely, open on a side facing away from the support surface. In other words, the rib chambers, in particular in the installed position of the headrest, in particular of the seat system, in the motor vehicle are at least partially, in particular completely, open to the rear as seen in the motor vehicle longitudinal direction. This means that the rib chambers are not covered by the main body, or are not delimited by the main body, to the rear on the side facing away from the support surface, or as seen in the vehicle longitudinal direction. The respective rib chamber is therefore prevented from being covered or delimited to the rear on the side facing away from the support surface, or as seen in the vehicle longitudinal direction, by the main body, in particular by the wall and/or by the ribs. This makes it possible to keep the weight of the headrest, or of the main body, particularly low.

The side facing the support surface can be understood in particular to mean a headrest, in particular a main-body, side facing the person seated on the seat system, in particular the driver. The side facing away from the support surface can be understood in particular to mean a seat-system, in particular a main-body, side facing away from the person seated on the seat system, in particular the driver. The side facing the support surface and the side facing away from the support surface are thus in particular sides that face away from one another. The sides are preferably at a spacing from one another in the motor vehicle longitudinal direction.

A further embodiment provides that a direction of longitudinal extent of at least one of the ribs runs in the vertical direction of the headrest and/or in the transverse direction of the headrest. In other words, at least one of the ribs extends in the vertical direction of the headrest and/or in the transverse direction of the headrest. The respective rib can therefore be in the form of a vertical rib or a horizontal rib. This makes it possible to achieve an ideal form of the main body for the mechanical loading arising during operation of the motor vehicle. This makes it possible to particularly increase the ability of the headrest to bear mechanical loads. For example, a direction of longitudinal extent of at least one of the ribs runs in the vertical direction and a direction of longitudinal extent of at least one further rib, which is different than that rib, runs in the transverse direction of the headrest. The vertical direction of the headrest in the installed position of the headrest, in particular of the seat system, in the motor vehicle preferably corresponds to a motor vehicle vertical direction. The transverse direction of the headrest in the installed position of the headrest, in particular of the seat system, in the motor vehicle preferably corresponds to a motor vehicle transverse direction.

A further embodiment provides that a direction of longitudinal extent of at least one of the ribs runs obliquely or perpendicularly to a direction of longitudinal extent of at least one other of the ribs, which in particular is different than that rib. In other words, at least two of the ribs extend obliquely or perpendicularly to one another. This means that a direction of longitudinal extent of at least a first one of the ribs runs in a first direction and a direction of longitudinal extent of at least a second one of the ribs, which in particular is different than the first rib, runs in a second direction which is different than the first direction, the directions running obliquely or perpendicularly to one another. In yet other words, the rib structure comprises at least one crossed ribbing. This makes it possible to bring about the ideal form for the mechanical loading of the headrest. This makes it possible to particularly increase the ability of the headrest to bear mechanical loads.

A further embodiment provides that the main body is at least partially, in particular completely, covered by a foam. In other words, the main body is at least partially, in particular completely, surrounded by the foam. This means that the main body can be at least partially, in particular completely, encased by the foam. The foam may thus be arranged, in particular directly, on the main body. This makes it possible for example to particularly increase a comfort of the headrest. In particular, a weight of the headrest can be kept particularly low.

The rib structure, in particular the main body, is preferably formed in one piece. This means that the rib structure, in particular the main body, is not formed by separately formed and interconnected parts. As an alternative, it may be provided that the rib structure, in particular the main body, is formed in multiple parts.

A second aspect of the invention relates to a motor vehicle seat system, having a headrest, in particular according to the first aspect of the invention. Advantages and advantageous embodiments of the first aspect of the invention are to be regarded as advantages and advantageous embodiments of the second aspect of the invention, and vice versa.

Further features of the invention emerge from the claims, the figures and the description of the figures. The features and combinations of features cited above in the description and the features and combinations of features cited below in the description of the figures and/or shown in the figures alone can be used not only in the respective specified combination but also in other combinations or individually.

The invention will now be explained in more detail on the basis of a preferred exemplary embodiment and with reference to the drawings.

### BRIEF DESCRIPTION OF THE DRAWINGS

FIG. 1 is a schematic and perspective partial view of a seat system according to an embodiment of the invention, which has a headrest according to an embodiment of the invention;

FIG. 2 is a schematic partial view, from the rear, of a seat system with a headrest according to an embodiment of the invention; and

FIG. 3 is a schematic and perspective view, in partial section, of a headrest according to an embodiment of the invention.

In the figures, elements that are the same or have the same function are provided with the same reference signs.

### DETAILED DESCRIPTION OF THE DRAWINGS

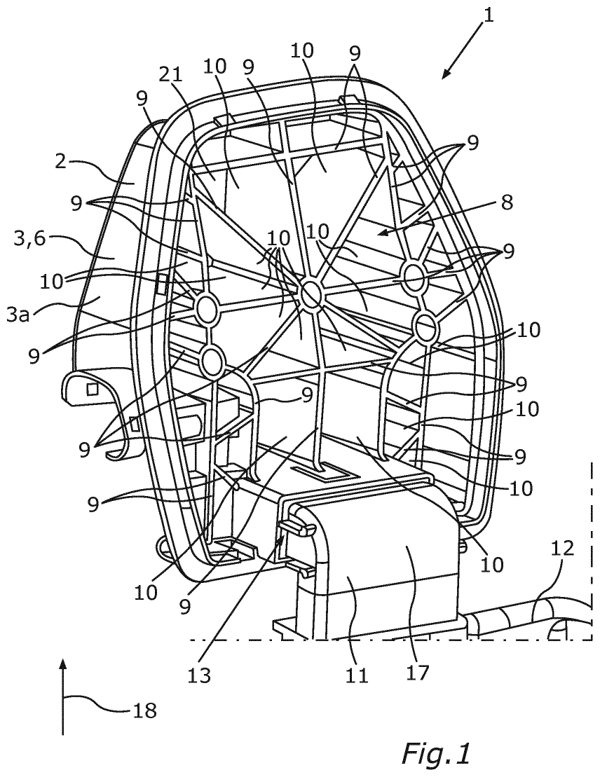

FIG. 1 shows a schematic and perspective partial view of a motor vehicle seat system 1. The seat system 1 has a headrest 2. The headrest 2 is therefore intended for the seat system 1. The headrest 2 has a main body 3. For example, the main body 3 has a frame part 3a.

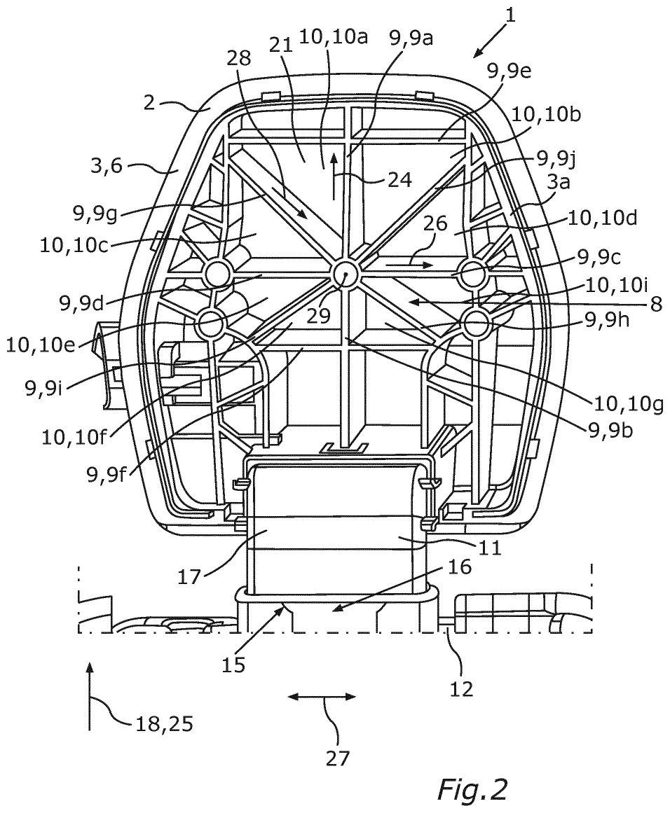

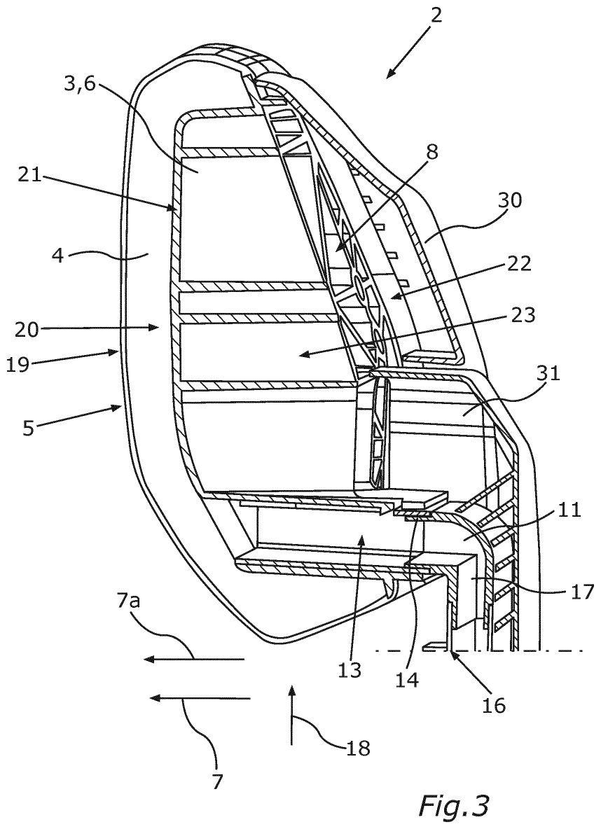

FIG. 2 shows the seat system 1, or the headrest 2, in a schematic partial view from the rear. FIG. 2 therefore shows a schematic rear view of the seat system 1, or of the headrest 2. The seat system 1, or the headrest 2, is illustrated slightly perspectively in FIG. 2. FIG. 3 shows a schematic and perspective view, in partial section, of the headrest 2.

The main body 3 is covered at least in certain regions by at least one upholstery 4, which is formed in particular separately from the main body 3. For example, the upholstery 4 comprises a cover 5, which is referred to in particular as upholstery cover. The main body 3 is at least predominantly, in particular completely, made from a plastics material 6. This makes it possible to keep a weight of the headrest 2 particularly low.

The seat system 1 is intended for a person, for example a driver of the motor vehicle, to sit on. The person seated on the seat system 1 can therefore support their head, in particular to the rear as seen in the vehicle longitudinal direction 7, on the headrest 2, in particular directly.

In order to be able to particularly increase an ability of the headrest 2, in particular of the main body 3, to bear mechanical loads and to be able to keep the weight of the headrest 2, in particular of the main body 3, particularly low, it is provided that the main body 3 comprises a rib structure 8 having a plurality of ribs 9, which partition off respective rib chambers 10 aligned in the vehicle longitudinal direction 7 from one another. A demolding direction of the respective rib chamber 10 therefore runs in the vehicle longitudinal direction 7, in particular to the rear. The rib structure 8 is, for example, arranged inside the frame part 3a.

The ribs 9 are preferably aligned in the vehicle longitudinal direction 7. This means that a demolding direction of the ribs 9 can run in the vehicle longitudinal direction 7, in particular to the rear.

It is preferably provided that the main body 3, in particular the headrest 2, is free of metal. This means that the headrest 2, in particular the main body 3, is made without using metal, in particular steel, and thus for example is not provided with a metal reinforcement, in particular steel reinforcement. This makes it possible to keep the weight of the headrest 2 particularly low.

A further embodiment provides that the headrest 2 has a holding element 11 for holding the headrest 2, in particular the main body 3, on a seat part 12, formed separately from the headrest 2, of the seat system 1. The seat part 12 is for example in the form of a backrest of the seat system 1. The headrest 2 held on the seat part 12 via the holding element 11, in particular the main body 3 held on the seat part 12 via the holding element 11, preferably can be reversibly detached from the seat part 12.

In the exemplary embodiment, the main body 3 has a receiving region 13, in which the holding element 11 is received or can be received. This means that a length region 14 of the holding element 11 is arranged or can be arranged inside the receiving region 13. A mounting direction 7a for receiving the holding element 11, in particular the length region 14, in the receiving region 13 preferably runs in the vehicle longitudinal direction 7, in particular forwardly. This means that the holding element 11, in particular the length region 14, can be removed from the receiving region 13 in the vehicle longitudinal direction 7, in particular rearwardly, to detach the headrest 2, in particular the main body 3, from the seat part 12. The holding element 11 can therefore be received in the receiving region 13 by moving the holding element in the vehicle longitudinal direction 7, in particular forwardly, and be removed from the receiving region 13 by moving the holding element in the opposite vehicle longitudinal direction 7, in particular rearwardly. For example, the receiving region 13 is at least partially formed, or delimited, by the rib structure 8, in particular by at least one of the ribs 9.

In the exemplary embodiment shown in FIG. 2, it is provided that the seat system 1, in particular the seat part 12, has a second receiving region 15, which is in particular at a spacing from the receiving region 13 and in which the holding element 11, in particular a second length region 16, which is at a spacing from the length region 14, of the holding element 11 is received or can be received. The headrest 2 is therefore held on the seat part 12 via the holding element 11, which is received in the first receiving region 13 and in the second receiving region 15.

The holding element 11 preferably has a third length region 17 arranged between the length region 14 and the second length region 16. This means that the length region 14 at least indirectly, in particular directly, adjoins the third length region 17 at one end and the second length region 16 at least indirectly, in particular directly, adjoins the third length region 17 at the other end. The third length region 17 is preferably curved, or arcuate. A direction of longitudinal extent of the length region 14 is therefore preferably different than a longitudinal extent of the second length region 16, with the directions of longitudinal extent of the respective length region 14, 16 running, for example, perpendicularly to one another. For example, the headrest 2, in particular the main body 3, is vertically adjustable, in particular in the vehicle vertical direction 18, in particular by means of the holding element 11. This can be brought about for example by moving the holding element 11, in particular the second length region 16, relative to the second receiving region 16.

A further embodiment provides that the headrest 2 has a support surface 19 intended for supporting the person's head, the rib chambers 10 being closed on a side 20 facing the support surface 19 by a wall 21 of the main body 3. In this case, in particular a basic shape of the headrest 2 can be formed, or described, by the support surface 19, or by the side 20 facing the person seated on the seat system 1, in particular the driver. The rib structure 8 is therefore located for example behind the wall 21 with respect to the vehicle longitudinal direction 7. As a result, the rib structure 8 can in particular be referred to as a background ribbing.

As an alternative or in addition, it is provided that the rib chambers 10 are at least partially open on a side 22 facing away from the support surface 19. This makes it possible to keep the weight of the headrest 2 particularly low.

A further embodiment provides that the main body 3 is at least partially, in particular completely, covered by a foam 23. This means that the main body 3 has an external form which can be encased by the foam 23, or which is encased by the foam 23. For example, the foam 23 is arranged on the side 20, in particular referred to as first side 20, and/or on the second side 22, in particular referred to as second side 22. For example, the rib chambers 10 are at least partially, in particular completely, filled by the foam 23.

A further embodiment provides that a direction of longitudinal extent 24 of at least a first one of the ribs 9a runs in the vertical direction 25 of the headrest 2. This means that the first rib 9a extends along the vertical direction 25. In the exemplary embodiment, a second one of the ribs 9b, which in particular is different than the first rib 9a and which extends along the vertical direction 25, is provided. The direction of longitudinal extent 24 of the first rib 9a therefore corresponds to a direction of longitudinal extent of the second rib 9b.

In the exemplary embodiment, a direction of longitudinal extent 26 of at least a third one of the ribs 9c, which in particular is different than the ribs 9a, b, runs in the transverse direction 27 of the headrest 2. This means that the third rib 9c extends in the transverse direction 27 of the headrest 2. For example, a fourth one of the ribs 9d extending in the transverse direction 27 of the headrest 2 is provided. The fourth rib 9d is preferably different than the ribs 9a-c. For example, a fifth one of the ribs 9e, which in particular is different than the ribs 9a-d and which extends in the transverse direction 27, is provided. For example, a sixth one of the ribs 9f, which in particular is different than the ribs 9a-e and which extends in the transverse direction 27, is provided.

The vertical direction 25 in the installed position of the headrest 2 in the motor vehicle preferably corresponds to the vehicle vertical direction 18. The transverse direction 27 in the installed position of the headrest 2 in the motor vehicle preferably corresponds to a motor vehicle transverse direction.

For example, the first rib 9a extends perpendicularly to at least one of the ribs 9c-9f, in particular to the ribs 9c-9f. For example, the second rib 9b extends perpendicularly to at least one of the ribs 9c-f, in particular to the ribs 9c-f. It may thus be provided that a direction of longitudinal extent 24 of one of the ribs 9a, b runs perpendicularly to a direction of longitudinal extent 26 of another one of the ribs 9c-f.

For example, a seventh rib 9g which in particular is different than the ribs 9a-f is provided. For example, an eighth rib 9h, which in particular is different than the ribs 9a-g, is provided. For example, a ninth rib 9i, which in particular is different than the ribs 9a-h, is provided. For example, a tenth one of the ribs 9j, which in particular is different than the ribs 9a-i, is provided. For example, at least one of the ribs 9g-j runs obliquely to at least one of the ribs 9a-f. In particular, the respective ribs 9g-f may each run obliquely to the ribs 9a-f. For example, the seventh rib 9g has a direction of longitudinal extent 28. It may therefore be provided that a direction of longitudinal extent 24, 26 of one of the ribs 9a-f runs obliquely to a direction of longitudinal extent 28 of another one of the ribs 9g-j.

For example, at least two of the ribs 9a-d, g-j, in particular the ribs 9a-d, g-j, are aligned relative to one another such that at least two of the ribs 9a-d, g-j, in particular the ribs 9a-d, g-j, or respective, in particular imaginary, elongations of the at least two respective ribs 9a-d, g-j, in particular the ribs 9a-d, g-j, intersect at a common, in particular imaginary, intersection point 29. For example, the ribs 9a and 9e intersect. For example, the ribs 9b and 9f intersect.

For example, a first one of the rib chambers 10a is at least partially, in particular directly, delimited by the first rib 9a, the fifth rib 9e and the seventh rib 9g. For example, a second one of the rib chambers 10b, which in particular is different than the first rib chamber 10a, is at least partially, in particular directly, delimited by the first rib 9a, the fifth rib 9e and the tenth rib 9j. For example, a third one of the rib chambers 10c, which in particular is different than the rib chambers 10a, b, is at least partially, in particular directly, delimited by the fourth rib 9d and the seventh rib 9g. For example, a fourth one of the rib chambers 10d, which in particular is different than the rib chambers 10a-c, is at least partially, in particular directly, delimited by the third rib 9c and the tenth rib 9j. For example, a fifth one of the rib chambers 10e, which in particular is different than the rib chambers 10a-d, is at least partially, in particular directly, delimited by the third rib 9c and the ninth rib 9i. For example, a sixth one of the rib chambers 10f, which in particular is different than the rib chambers 10a-e, is at least partially, in particular directly, delimited by the sixth rib 9f and the ninth rib 9i. For example, a seventh one of the rib chambers 10g, which in particular is different than the rib chambers 10a-f, is at least partially, in particular directly, delimited by the second rib 9b, the sixth rib 9f and the eighth rib 9h. For example, a ninth one of the rib chambers 10i, which in particular is different than the rib chambers 10a-h, is at least partially, in particular directly, delimited by the third rib 9c and the eighth rib 9h.

In the exemplary embodiment shown in FIG. 3, at least one covering element 30, which in particular is formed separately from the main body 3 and which at least partially, in particular to the rear as seen in the vehicle longitudinal direction 7, covers the main body 3, in particular the rib structure 8, is provided. For example, the covering element 30 is made from a plastics material. For example, the holding element 11 comprises a support region 31, which in particular is different than the length regions 14, 16, 17 and via which the main body 3, in particular the rib structure 8, is supported in the vehicle longitudinal direction 7, in particular rearwardly, in particular directly, on the holding element 11, in particular on the seat part 12.

### LIST OF REFERENCE SIGNS

1 Seat system
2 Headrest
3 Main body
3a Frame part
4 Upholstery
5 Cover
6 Plastics material
7 Vehicle longitudinal direction
7a Mounting direction
8 Rib structure
9 Ribs
9a First rib
9b Second rib
9c Third rib
9d Fourth rib
9e Fifth rib
9f Sixth rib
9g Seventh rib
9h Eighth rib
9i Ninth rib
9j Tenth rib
10 Rib chambers
10a First rib chamber
10b Second rib chamber
10c Third rib chamber
10d Fourth rib chamber
10e Fifth rib chamber
10f Sixth rib chamber
10g Seventh rib chamber
10h Eighth rib chamber
10i Ninth rib chamber
11 Holding element
12 Seat part
13 Receiving region
14 Length region
15 Second receiving region
16 Second length region
17 Third length region
18 Vehicle vertical direction
19 Support surface
20 First side
21 Wall
22 Second side
23 Foam
24 Direction of longitudinal extent
25 Vertical direction
26 Direction of longitudinal extent
27 Transverse direction
28 Direction of longitudinal extent
29 Intersection point
30 Covering element
31 Support region

1.-10. (canceled)

11. A headrest for a motor vehicle seat system, comprising:
a main body which is covered at least in certain regions by an upholstery and is at least predominantly made from a plastics material, wherein
the main body comprises a rib structure having a plurality of ribs, which plurality of ribs partition off respective rib chambers aligned in a vehicle longitudinal direction from one another.

12. The headrest according to claim 11, further comprising:
a holding element for holding the headrest on a seat part, formed separately from the headrest, of the seat system.

13. The headrest according to claim 12, wherein
the headrest held on the seat part via the holding element is reversibly detachable from the seat part.

14. The headrest according to claim 12, wherein
the holding element is received in a receiving region of the main body, and
a mounting direction for receiving the holding element in the receiving region runs in the vehicle longitudinal direction.

15. The headrest according to claim 11, wherein
the main body is free of metal.

16. The headrest according to claim 11, wherein
the headrest has a support surface configured to support a person's head, and
(i) the rib chambers are closed on a side facing the support surface by a wall of the main body, and/or
(ii) the rib chambers are at least partially open on a side facing away from the support surface.

17. The headrest according to claim 11, wherein
a direction of longitudinal extent of at least one of the ribs runs in a vertical direction of the headrest and/or in a transverse direction of the headrest.

18. The headrest according to claim 17, wherein
a direction of longitudinal extent of one of the ribs runs obliquely or perpendicularly to a direction of longitudinal extent of another one of the ribs.

19. The headrest according to claim 11, wherein
the main body is at least partially covered by a foam.

20. A motor vehicle seat system comprising a headrest according to claim 11.
